(19) United States
(12) Patent Application Publication
(10) Pub. No.: US 2020/0127601 A1
(43) Pub. Date: Apr. 23, 2020

(54) SUNLIGHT COLLECTION AND TRANSPORTATION SYSTEM

(71) Applicant: Orenko Limited, Cambridge (GB)

(72) Inventor: Elias TOWE, Pittsburgh, PA (US)

(21) Appl. No.: 16/163,210

(22) Filed: Oct. 17, 2018

(51) Int. Cl. H02S 40/20; H02S 40/42; G02B 6/44; G02B 6/26; H02S 20/32; G02B 19/00; F24S 23/00

(52) U.S. Cl. CPC H02S 40/20; H02S 40/42; G02B 6/4415; F24S 23/12; H02S 20/32; G02B 19/0042; G02B 19/0023; G02B 6/26

(57) ABSTRACT

A solar collector energy conversion system has a solar collector apparatus adapted to collect sunlight at a collection location and direct it to one or more light transport guides for transporting the sunlight to a conversion location separate from the collection location, and a solar energy conversion apparatus arranged at the conversion location and adapted to receive sunlight transported by the light transport guides and to convert the transported sunlight to an alternative form of energy.

### TECHNICAL FIELD

The present invention relates generally to collecting and transporting solar energy.

### BACKGROUND

A number of solar energy conversion methods and related technologies have now been integrated into the mix of large-scale energy production systems in many parts of the world. Systems and processes are known that convert sunlight directly to electricity via arrays of photovoltaic panels.

The majority of deployed photovoltaic systems are based on silicon semiconductor material, whose native properties, combined with some engineering related issues, have constrained the achievable solar-to-electric energy conversion efficiency in production grade panels to a maximum of about 20%. A theoretical maximum for silicon-based solar cells of about 33.7% has been predicated; this is known as the Shockley-Queisser detailed balance limit [W. Shockley and H. J. Queisser, “Detailed balance limit of efficiency of p-n-junction solar cells,” J. Appl. Phys. 32 pp. 510-519 (1961)]. An immediate consequence of the conversion efficiency constraint on production grade panels is the necessity to cover large areas of land or rooftops with silicon semiconductor material in order to achieve useful electric power generation capacities for individual households; this, in turn, means much larger land areas must be covered with silicon for utility-scale grid distribution.

Conventional direct conversion of sunlight to electricity through use of solar panels integrates two functionalities: that of collecting the sunlight, and immediately converting it to electricity in one system—the panel. It is difficult to optimize the light collection optics in this configuration, which caps useful efficiency levels. Also, this design approach does not allow the upgrading of active solar conversion devices in the field if better ones come along. Once installed, conventional solar panels are expected to be in operation for durations of 10 to 20 years. Because of the substantial investment made in such installations, it is inconceivable to replace them even if newer solar cells or panels with substantial performance improvements come along. It is in this context, among several others, that a new approach is needed. Fibre optical guides have been proposed for sunlight collection and transport since the 1970s [C. J. Swet, “Fiber optical solar collector,” U.S. Pat. No. 3,780,722, (1973)], there are currently no commercially deployed systems.

### SUMMARY

According to one aspect of the invention there is provided a solar collector energy conversion system having a solar collector apparatus adapted to collect sunlight at a collection location and direct it to one or more light transport guides for transporting the sunlight to a conversion location separate from the collection location, and a solar energy conversion apparatus arranged at the conversion location and adapted to receive sunlight transported by the light transport guides and to convert the transported sunlight to an alternative form of energy.

According to another aspect of the invention, there is provided a solar collector energy conversion system comprising: a solar collector apparatus adapted to collect sunlight at a collection location, the solar collector apparatus comprising an array of solar collector modules mounted on a support and oriented to collect sunlight, wherein each solar collector module in the array is attached to a respective optical-fiber, wherein the optical-fibers from the array are housed in a primary cable for transporting the sunlight from the collection location to a conversion location separate from the collection location; and a solar energy conversion apparatus arranged at the conversion location and adapted to receive sunlight transported by the optical fibers and to convert the transported sunlight to an alternative form of energy.

In one embodiment, the solar collector apparatus is an array of solar collector modules arranged on a support so that it can track the movement of the sun. The solar collector apparatus may comprise a plurality of arrays. Each array may have a primary cable which is housed in a super cable. Embodiments of the present invention described herein introduce a universal methodology for harvesting and transporting sunlight to wherever it can be conveniently converted to other forms of energy such as electric or heat energy. It could alternatively be used without conversion to other forms for example in lighting. According to embodiments described herein, light is first collected, and then delivered to a location away from where it is collected, before it is converted to another form of energy (or used without conversion). The light transport guides may take the form of flexible optical-fibers referred to herein as a fiber-optic waveguides in some places. It will be appreciated that the terms ‘optical-fiber’ and ‘fiber-optic waveguides’ may be used interchangeably. Flexible fiber-optic guides can be assembled and packaged into bundles or primary cables, each containing 10 to 100 fibers, whose minimum length is suited to the difference between the collection location and the conversion location. This may be greater than 25 m, for example of the order of 30-50 m, or longer. In one embodiment, the length can be half a kilometer; fiber-optic cables can be concatenated end-to-end to create much longer cables spanning required distances that could be as long as the breadth or length of a continent. The actual length of a concatenated fiber-optic cable will depend on acceptable maximum attenuation level for a particular use case. In practice, allowable attenuation rates should be less than 0.5 dB/km. The primary cable may also be flexible. Super cables, assembled from said bundles or primary cables, may contain a minimum of 4 primary cables. Super cables with more primary cables may be assembled as long as the resulting super cable retains flexibility to allow for maneuverability during installation. A few such super cables can facilitate transport of several tens of kilowatts to several megawatts of sunlight power to remote light conversion or processing centers.

Once sunlight has been coupled to fiber-optic waveguides, it can be transported safely by routing the ‘super’ cables to any desirable location where the energy can be further processed or manipulated into a desired form. The distances over which sunlight might be transported can be as short as a few tens of meters away from where it is collected, or the distances can span a city, a country or even a continent as long as intrinsic and extrinsic fiber absorption losses and coupling losses are reduced to their minimum. For example, the distance could be 25 m, or greater than 25 m, for example between 30 m and 50 m, or a minimum of half a kilometer.

This revolutionary approach also enables true integration of different forms of energy converted from sunlight. As discussed in the background section, one approach of solar energy conversion is direct conversion from sunlight to electricity using photovoltaic panels. Another existing approach uses what might be termed ‘indirect conversion’. This involves a scheme that initially concentrates sunlight into intense beams for heating a thermal fluid such as molten salt, which is then used to convert water to steam which can in turn drive a turbine to generate electricity. In a known context, where the sunlight is concentrated at the point at which it is converted, this approach has many drawbacks. In regions of the world with high annual average insolation, concentrated solar thermal systems can be constructed to be more effective and efficient than photovoltaic systems in principle, but there are limitations. The tall tower structures that serve as the focal points for the concentrated solar radiation, for example, are often an environmental or an ecological hazard. In such systems, many acres of land are covered with mirrors to form a solar field that directs and focuses extremely intense sunlight beams onto a central receiver in a tall tower structure where a heat transfer fluid is located. Any birds flying above the solar field in the vicinity of the tower or generally in the path of multiple light beams that are packed with the high intensity light are incinerated.

These disadvantages can be substantially mitigated by the approach described herein wherein sunlight is collected at a collection location and then transported to an energy conversion location using optical waveguides. This opens up a raft of possibilities for addressing many of the limitations with existing direct conversion and indirect conversion approaches.

In the following described embodiments, an apparatus and a system for collecting sunlight is discussed wherein a provision is made to gather the maximum solar energy possible at any given time of day. Such an apparatus can be comprised of an array of miniature collector, with means for pointing the array to the most optimal alignment with the sun for collecting the most sun at any given time of day. As an example, each miniature collector module (dish) may have a diameter of about 15 cm. An array comprised of 64 such modules would be capable of capturing about 1.24 kW of power, assuming an insolation rate of 1 kW/m², which is typical of the sunny regions of the world. It will be appreciated that this size is exemplary only, and other suitable sizes and number of modules may be used as the context requires.

Where the solar collection apparatus comprises an array of individual collector modules, each collector module in the array may have attached to it a light transport waveguide capable of delivering sunlight along its length for distances of up to 1 km with minimal loss on the order of 10 dB per kilometer or less over the spectral band in which most solar energy is contained. For example, suitably engineered silica-based light transport waveguides may be capable of transporting light rays that span the wavelength range from 350 nm to 2500 nm, which corresponds to the spectral band where most (around 95%) of solar energy reaching earth is concentrated. Waveguides may be connected together end to end to increase the distance of the light transfer. With new-generation non-silica based cables, distances exceeding 1 km may be enabled. Sunlight may be transported over any minimum distance, for example of 1 meter, ½ meter or even less if the context permits.

As mentioned above, existing direct conversion approaches are such that in all existing photovoltaic [PV] systems, the PV panels integrate the sunlight gathering surface onto the conversion substrate making it impossible to contemplate other uses for the collected sunlight or replacement of any of the components when it is technically necessary. The new approach described herein removes these restrictions. As such, the collected sunlight might be transported to an energy conversion location where it is converted into electricity, or to a different location where it is converted into thermal energy, or to a location where no conversion takes place (for example it may be used as lighting). It may also be noted that the sunlight might be guided to different locations at different times of the year or for different purposes. That is, the arrays are multipurpose and can collect sunlight for a multitude of different applications.

By separating out the collection of light from its use, it is possible to consider methods and structures which allow for simple upgrading of technical components of the apparatus. For example, according to embodiments described herein a light cabinet is described which has racks for accommodating a scheme for converting sunlight to electricity using photovoltaic solar cell technology. The solar cells can be in the form of chips whose sizes can range from a few square millimeters to several tens of square centimeters. The transported sunlight is delivered to the racks via the light transport guides, and the same light transport guides can be used to distribute light over the solar cell chips. Alternatively, light transport guides can be connected together. The chips may be mounted on carriers, and both the bank of chips and the carriers on which they are mounted may be standardized to allow easy replacement of the chips (by replacing an entire chip carrier with a new one that possesses a new bank of chips that is mounted upon it).

A particularly advantageous method of coupling sunlight from a fiber-optic cable onto the solar cell chip is further described herein. The sunlight is coupled into a light box where several delivery fibers inject light into a cavity so that light from multiple fibers can mix and scatter at engineered surfaces and at an optical diffuser attached to the surface of the light box that faces the solar cell chip. The output of the diffuser may be a uniform square or rectangular shaped beam of light, whose size precisely matches the size of a solar cell chip under the light box.

The solar cell chip carriers may be mounted on a high thermal conductivity material such as copper to provide a thermal management scheme for the chips. A coolant piping system may be embedded within the block of high thermal conductivity material so as to allow delivery of coolant into and out of the block. Such a thermal management scheme may be integrated to an external heat exchanger to form a closed loop cooling system.

In an alternative application, the sunlight is used to heat thermal storage micro particles by scanning optical-fibers transporting the sunlight over a surface carrying the micro particles. Alternatively, the optical-fibers transporting the sunlight can be used to heat other types of heat transfer fluids such as, for example, molten salt.

In yet another application, it is possible to use concentrated light transported in an optical fiber for photovoltaic conversion and for the heating of particles at the same time. That is, a common system of collector arrays could feed both an electricity conversion system and a thermal conversion system.

The solar collector apparatus of the solar collector energy conversion system may comprise an array of solar collector modules that are mounted on a support and oriented to collect sunlight. Each module in the array of solar collectors is attached to respective optical-fibers, wherein the optical-fibers from the array are housed in a cable which transports the sunlight from the collection location to the conversion location.

Each optical-fiber attached to the solar collector modules may have a length between 0.5 km and 1 km, and preferably longer than 1 km, and is engineered to transmit sunlight in the range of wavelengths from 350 nm to 2500 nm.

In certain configurations, the collection location may be less than 100 m away from the conversion location. For example, the collection and conversion locations may only be separated by a distance of 20-50 m. In instance when the two locations are less than 100 m, the optical fiber and primary cable may be less than 100 m. The length of the optical fibre may be adapted to the separation distance.

According to another aspect of the invention, there is provided a method of converting sunlight to an alternative form of energy comprising: collecting sunlight at a collection location; transporting the sunlight to a conversion location separated from the collection location by a distance greater than 25 m using at least one optical-fiber; coupling the at least one optical-fiber to a conversion apparatus at the conversion location; and producing by the conversion apparatus the alternative form of energy from the sunlight transported by the at least one optical-fiber.

In some embodiments of the invention, the alternative form of energy is electricity. The optical fiber may be coupled to a light collection housing at the conversion location. The light collection housing produces a beam from the transported sunlight, which is directed to a photovoltaic component.

In other embodiments, the alternative form of energy may be heat. The optical fibers transporting the sunlight may move relative to a surface carrying thermal storage particle. The thermal storage particles may be heated by scanning the optical fibers relative to the surface.

The optical fibers may be housed with multiple optical fibers in parallel alignment in a flexible primary cable which extends for at least 25 m. In some embodiments, the primary cable may extend for at least 0.5 km.

According to a third aspect there is provided a solar collector module comprising: a concave collection surface, which is reflective, and which is configured to collect sun rays and to reflect them towards a mirror location; a mirrored surface located at the mirror location to receive sun rays reflected from the collection surface and to reflect the sun rays to a light receiver coupleable to the collector module at a light collection region of the collector module; and coupling means operable to couple the light receiver to the collector module at the light collection region of the collector module.

In one example the solar collector module may be used in combination with a light receiver in the form of at least one optical-fiber.

In one example the concave collection surface is a truncated parabola rotated about its origin.

In certain configurations, the mirror location in the solar collection module is located at a first focal point of the concave collection surface, the first focal point located along a central axis of the collector module, and the light collection region is located at a second focal point spaced from the first focal point along the central axis of the collector module.

The solar collector module may comprise a transparent covering which extends over the upper area of the collector module. This cover should transmit sunlight in the spectral band between 350 nm and 2500 nm.

In certain configurations the apparatus comprises an array of solar collector modules, as defined above. The array of solar collectors may be mounted on a movable support to track the movement of the sun.

According to a fourth aspect there is provided an optical-fiber comprising an elongated cylindrical glass core surrounded by cladding of a refractive index smaller than that of the core, the optical-fiber designed to transmit light in the range of 350 nm to 2500 nm, and not in a band of 20 nm centered around 1430 nm. Such fiber-optic cables may be manufactured from silica glass with a solid or a hollow core. Silica is one of the most developed glass materials and is currently the workhorse for global light-wave communication systems. Alternatively, the fiber-optic guides in the cables may be manufactured from fluoride glass, which offers continuous light transmission from 250 to 8000 nm with minimal absorption. Fluoride glasses, in theory, could provide much lower overall intrinsic attenuation losses than silica.

The optical fiber may have a glass core which has a diameter between 100 μm and 1 mm. The optical fiber may be housed in a primary cable located in parallel alignment with multiple optical fibers in the primary cable.

For a better understanding of the present invention and to show how the same may be carried into effect reference will now be made by way of example to the accompanying drawings.

### BRIEF DESCRIPTION OF THE DRAWINGS

FIG. 1A shows an array of solar collector modules for harvesting sunlight at a collection location

FIG. 1B is a sectional view through a solar collector module

FIG. 2A is an open side view of a light cabinet

FIG. 2B is front open view of a light cabinet

FIG. 2C is a detailed sectional of view through an electrical conversion assembly

FIG. 2D is an expanded view of the electrical conversion assembly

FIG. 2E is a sectional view through a light box

FIG. 2F is a sectional view of a light box

FIG. 3 is an expanded view of multiple electrical conversion assemblies associated with a single rack of the cabinet

FIG. 4 is a plan view showing the coolant system in a chip carrier

FIG. 5 is a perspective view showing the arrangement of a chip carrier within its carrier block

FIG. 6 is a plan view of a chip carrier carrying multiple PV chips

FIG. 7 is a schematic view of a thermal energy storage system

FIGS. 8A and 8B illustrate a thermal receiver

FIG. 9 illustrates a heat exchanger

### DETAILED DESCRIPTION

Separating the process of collecting sunlight from that of converting it to other forms of energy potentially offers a number of advantages that include improving the efficiency of each process. The two processes can be separated, for example, by transporting the collected sunlight through fiber-optic waveguides to a different and remote location where it can be processed.

The present invention discloses a system for collecting light at a collection location and transporting it to a different location for conversion. It is known that optical power in the milliwatt range at certain wavelengths of light (specifically at 1.3 μm and 1.55 μm) can be transported with minimal attenuation through optical fibers to any desirable location as is currently done in modern light-wave communication systems. However, transporting (artificial or sun) light power in the kilowatt to megawatt range over any material distances has never been accomplished. This invention is concerned with transport and subsequent use of sunlight power (over the spectral range from 350 to 2500 nm) in the kilowatt to megawatt range at distances greater than 100 m, preferably greater than half a kilometer. In some embodiments, large distances can be covered extending over oceans and continents. In come embodiments, power levels between 10 kW and 200 MW may be transported. In a microgrid class embodiment, power levels between 100 kW and 1 MW can be transported. In a small utility class embodiment, power levels between 1 MW and 30 MW can be transported and in a further large utility class embodiment, power levels larger than 30 MW can be transported.

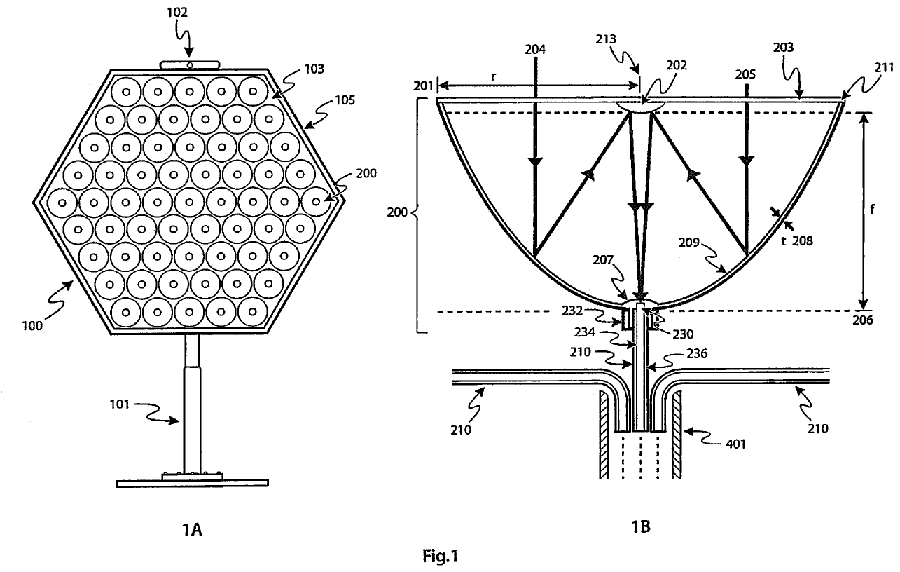

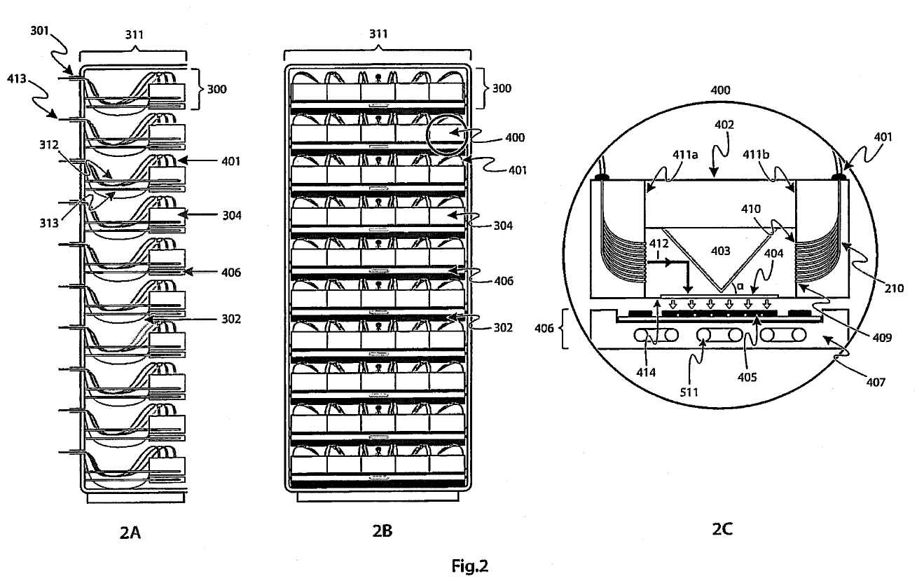

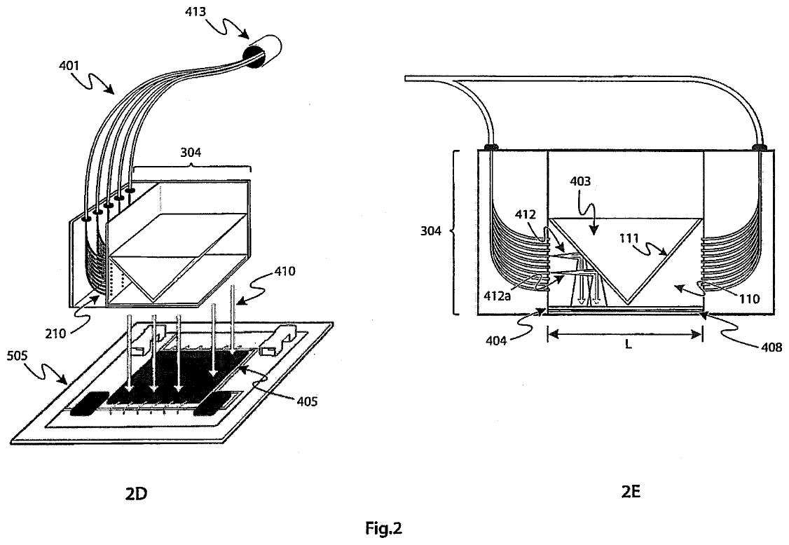

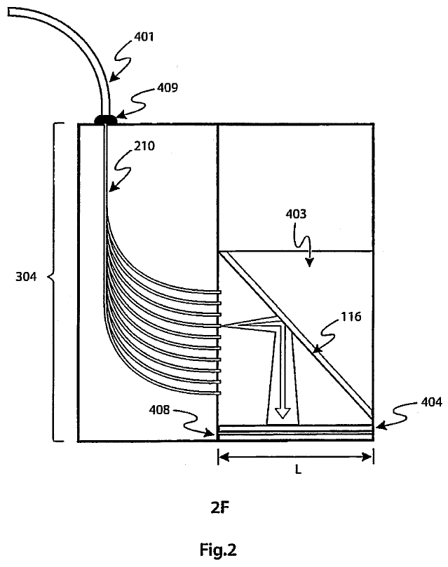

FIGS. 1A and 1B illustrate a solar collection system which comprises one or more arrays 100 of solar collector modules 200. Each solar collector module is dish-shaped and acts to receive sunlight rays 204, 205 from its upper flat or open surface and to direct that sunlight using optical components to a light receiver 210 located at the lower central region of the dish. In the described embodiments, the light receiver 210 is a fiber-optic waveguide 210. The fiber-optic waveguide 210 from each solar collector module in the array can be collected together and housed in a fiber-optic cable 401 for each array. The fiber-optic cables are then collected together and housed in a ‘super’ fiber-optic cable 413 (shown in FIG. 2D).

In the present description, the term optical-fiber is used interchangeably with fiber-optic waveguide to denote a long cylindrical silica glass core surrounded by a cladding whose index of refraction is smaller than that of the core. The cladding in turn is surrounded by a protective polymer coat. The entire structure is encapsulated in a hard protective but flexible outer polymer layer called the jacket. The term fiber strand is used herein also to denote a single optical-fiber waveguide. The phrase ‘optical-fiber (or fiber-optic) cable’ is used to denote a tough, flexible, protective thermoplastic housing with multiple optical-fibers for the purpose of light transport. ‘Super’ optical-fiber cables can be provided for carrying multiple cables over long distances.

The revolutionary arrangement described herein thus enables sunlight to be collected at a location where sunlight is plentiful (a collection location), and transported to a location separated from the collection location. The distance of separation could be small or large, and is limited only by the possible length of fiber-optic cables and any absorption losses, per unit length, that may reduce the amount of light along its path.

For example, the transport distance may be in the range from less than ½ meter (but greater than 1 cm) or greater than 1 km. Once coupled into fiber-optic waveguides, sunlight can be transported safely by routing the fiber-optic cables housed in the ‘super’ cables to any desirable location where the sunlight energy can be further processed or manipulated into a desired form (electrical or thermal). The distances over which sunlight might be transported can be as few as tens of meters away from where it is collected, or the distances can span a city, a country or even a continent as long as most fiber absorption losses and coupling losses can be minimized.

The embodiments of the invention described herein thus introduce a radical approach that separates the process of harvesting sunlight from its immediate utilization or conversion to other forms of energy. Instead of the integrated approaches that have been developed in the past, the present approach separates the processes involved in solar energy harvesting and the use of that energy.

FIG. 1A shows an assembly of paraboloid solar collector modules 200 in an array 100 on a supporting surface 103 that is mounted on a pedestal 101. The pedestal 101 has a rack 105 on which the hexagonal collector array 100 is mounted. To follow the daily movements of the sun, the collector array 100 is provisioned with a two-axis, motor-driven (not shown) system for positioning and pointing the entire structure to the most optimal direction for collecting the most sunlight at any time during a sunny day. A solar tracking sensor 102 provides a control signal for driving a programmable logic controller [not shown] that controls the two-axis tracking system. Details of the two-axis tracking system and the programmable logic controller are not described further herein, because they are known systems which are currently used to control the angle of orientation of solar panels which could be adapted for this purpose. The individual collector modules can be arranged in the array in any two-dimensional geometric shape desired. However, the arrangement in this embodiment is such that the final geometric form, when looked at from a plan view, is a hexagon. This arrangement is preferred in some contexts because it is predicated on a geometric optimization principle that produces a hexagon as the ideal geometric form for the highest packing density (per unit area) for arranging dish-shaped, concave structures with circular rims, resulting in an effective surface coverage of about 91%.

Each collector module 200 may be designed to securely fit inside a holding substructure 103 in a manner that allows simple removal and replacement. Alternatively, a complete array of collector modules can be fabricated as a single structure which can easily be removed and replaced from the rack 105.

A single collector module 200 is shown in FIG. 1B. The collector module 200 is a hollowed-out paraboloid dish formed from an appropriately truncated parabola that is rotated about its origin. The dish has a focal length f 206 measured from a point 213 at the center of the circular upper area of the dish along the central axis, to a collection region 207 at the surface of the dish. In one embodiment the paraboloid collector module 200 is designed to have the radius r 201 of its circular rim 211 be exactly equal to the focal length f 206 of the dish, but in other embodiments it is possible that the radius of the circular rim does not necessarily have to be equal to the focal length. Such a structure can be easily manufactured by casting from a single paraboidal mold. Alternatively, a large array of them arranged in the shape of the designed collector array 100 of FIG. 1A could be made in a single mold. The thickness t 208 of the wall of the collector module 200 may be minimized for any specific material out of which the module is made, subject to certain trade-offs mentioned below. If the module is made from polymeric glass materials, such as poly-methyl-methacrylate (PMMA), also known as acrylic glass, the thickness can be a few millimeters. The exact thickness can be chosen as an engineering trade-off between mechanical robustness and the weight of a single collector module (or array of modules). If it is too thin, it could be susceptible to damage from handling or ambient turbulence, but if it is too thick and therefore heavy, it could contribute too much weight to the total weight of the collector array 100. The total weight of the collector array 100 should directly balance a need for structural robustness and a requirement for low power for operating the tracking systems that control the alignment and pointing of the array 100 to the optimum position of the sun. For an array made from acrylic glass material, a thickness of 1 mm for the module material would be ideal; this would result in the weight of a single, completely sealed collector module being 41.56 grams if the external rim diameter is 15 cm, and its internal rim diameter is 14.9 cm. For this illustrative example, we have taken the radius of the module to be equal to its focal length. The weight of 64 such collector modules would be about 2.66 kg (assuming a density of 1.18 grams/cm³ for PMMA).

While a paraboloid collector module 200 is described herein, it will readily be appreciated that different shapes may be utilized. What is required is a collector module that is capable of receiving solar radiation, with optical components that guide the solar radiation to a light receiver in the form of an optical-fiber. In the present embodiment, a concave collection surface is provided which is reflective and which is configured to collect sun rays and to reflect them towards a location at which a mirror is mounted. The mirror receives sun rays reflected from the collection surface and redirects them to a light collection point where a light receiver such as an optical-fiber can be coupled. Any shape which satisfies these criteria, with any suitable optical guiding components may be utilized in accordance with the principles described herein.

In the embodiment described herein the solar collector apparatus comprises collector modules which utilize reflection to collect and guide the sunlight onto the light receiver. Once the principles of separately harvesting the sunlight at a collection location, and guiding it using optical fibers to a utilization location are understood, it will readily be appreciated that other alternatives may be available for collecting the sunlight. For example, sunlight may be collected using refractive rather than reflective optics. Refractive optics involves use of lenses alone. It would be possible to use arrays of convex lenses or Fresnel lenses to focus the light to a point where a fiber can be placed to capture it. Having said that, there may be advantages to utilizing reflective optics. Achieving the right precision on a large array of lenses involved in refractive optics may be harder than achieving the same precision using mirrors. Furthermore, some lenses have a defect called ‘chromatic’ aberration that may be unavoidable, while mirrors do not suffer from this. Another important consideration is weight. Conventional lenses need to have a thickness to refract light, which adds weight. A mirror, on the other hand, may be as thin as required.

A possible way to address these challenges is to provide a metalens, which may be comprised of microscopically engineered surface features that permit fabrication of a flat lens for focusing of a certain wavelength band; full spectrum metalenses are however still challenging to fabricate.

To enhance proper functioning, the concave inner lining of each module 200 in the collector array 100 should desirably be coated with a broadband high reflectivity film 209 or stack of films. The reflectivity for the inner lining 209 for each module 200 in the array should be 100% for sunlight wavelengths spanning the spectral range from 350 nm to 2500 nm. Most energy (about 95%) from the sun reaching the earth is concentrated within this spectral band. The energy is distributed non-uniformly in the solar spectrum. It is estimated that about 4% is contained between 300 nm and 400 nm; 42% between 400 nm and 700 nm, and 52% between 700 nm and 2500 nm. In a fully assembled collector array, each module 200 in the array has a thin transparent glass cover 203 extending over the open area defined by the rim 211 of the dish; this may be made from lightweight, durable, and ultraviolet-resistant plastic material, such as acrylic glass. The cover 203 serves the dual role of protecting the concave inner lining 209 of the module from the elements as well as acting as an input port for parallel incident solar radiation rays 204 and 205 into the collector module. Solar radiation rays, such as 204 and 205, are reflected from the inner lining 209 and, because of the particular parabolic curvature of the module, redirected toward the focal point 213 of each dish in the vicinity of the center of the cover glass. A perfect hyperboloid mirror reflector 202, attached to the center of the cover 203 and positioned in the vicinity of the dish focal point, retro-reflects and refocuses the light to the bottom of the dish to the collection region 207, below which is attached a fiber-optic waveguide 210 with an appropriate numerical aperture. Here, numerical aperture is defined as a dimensionless parameter that characterizes the range of angles of incident sunlight rays that are successfully captured by the fiber and are thus readily transported along its length.

The fiber-optic waveguide 210 may be attached by any suitable mechanism. In one embodiment, a screw thread around a ferrule can be created at the fiber tip 230, and a corresponding threaded body 232 can be provided at the collection point 207 of the collector module such that the tip 230 of the fiber-optic strand can be screwed into the threaded region at the bottom of the module. Technology for securing optical-fibers to curved and planar surfaces are known and may be adapted for use herein.

The fiber-optic waveguide 210 may have a circular cross-section core waveguide 234 whose diameter may range from 100 microns to 1 millimeter and whose cladding thickness can range between 150 microns and 1 millimeter. It will readily be appreciated that other dimensions may also be appropriate, depending on the context. In some examples, a fiber-optic waveguide for a single collector module could be capable of transporting a minimum of 10 W of sunlight for a distance of at least 1 km with minimal loss (<10 dB/km) over most of the spectral band in which the majority of solar energy is contained. Greater distances may be enabled depending on the context. Over the majority of the spectrum, the loss should be below 5 dB/km. For good performance and to maximize efficiency, the fiber-optic waveguides 210 should exhibit broadband transmission of sunlight beginning from the wavelength of 350 nm and ending at the wavelength of 2500 nm. The inventor has recognized certain spectral features of sunlight when considering the transportation requirements which have not hitherto been studied in depth; the inventor has recognized that it is desirable that the sunlight transmission capability of the silica fiber between the wavelengths of 350 nm and 450 nm be greater than 20%, and between 450 nm and 700 nm, it should be greater than 85%, and between 700 nm and 1700 nm it should be 90% or greater, except for a narrow band of about 20 nm centered around the atmospheric water vapor absorption line at the wavelength of 1430 nm, where the transmission may dip to almost zero. This dip is of no consequence because there is little to no incident solar radiation at this wavelength due to atmospheric absorption of sunlight. The inventor has recognized that this is because the same absorption mechanisms (water molecules and hydroxyl ions) in the atmosphere are also present in the manufacture of glass fibers (from humidity in the air). Between the wavelengths of 1450 nm and 1900 nm, the fiber transmission should preferably be greater than 85%, and between 1900 nm and 2000 nm, it should preferably be better than 70%. For the remainder of the solar spectrum between 2000 nm and 2500 nm, the fiber transmission is expected to be between 15% and 70%. Low transmission in the last spectral region should not be a problem because the amount of solar energy carried in this portion of the spectrum is less than 1%. The most critical aspect is that the spectral transmission characteristic of the fiber should closely follow the distribution of solar energy reaching the earth as described above. This means that where there are dips in the solar energy spectrum reaching earth, the silica fiber may have similar dips in transmission since there is little energy to transmit. Overall, however, the delivery of sunlight through a fiber-optic waveguide should incur very little loss of light, certainly no more than 10 dB/km at worst but below 5 dB/km at best, over the spectral band in which most solar energy is contained. Ideally, fiber made from glass that does not attenuate the sunlight at all (and continuously) transmits 100% of sunlight between 350 nm and 2500 nm should be used.

The inventor has recognized that, for transmission of the collected light over distances of 0.5 km or greater, it is desirable that the sunlight transmission capability of the silica fiber may be narrower than those disclosed above. It may be desirable that the sunlight transmission capability of the silica fiber between the wavelengths of 350 nm and 450 nm be greater than 70%, and between 450 nm and 700 nm, greater than 90%, and between 700 nm and 1700 nm, 95% or greater, except for a narrow band of about 20 nm centered around the atmospheric water vapor absorption line at the wavelength of 1430 nm, where the transmission may dip to almost zero. Between the wavelengths of 1450 nm and 1900 nm, the fiber transmission should preferably be greater than 90%, and between 1900 nm and 2000 nm, it should preferably be better than 70%. For the remainder of the solar spectrum between 2000 nm and 2500 nm, the fiber transmission is expected to be between 50% and 70%.

The flexible fiber-optic waveguides 210 may be collected or packaged together in one or more bundles, or primary cables 401. These primary cables 401 may contain 10 to 100 fibers 210. The minimum length of each fiber 210 may be 0.5 km. Multiple fiber-optic cables 401 may be concatenated end-to-end, creating a ‘sung-fit’ connection wherein the optical cables are automatically aligned. Connecting optical cables in this way is known in the art. By concatenating the cables 401 together, a longer cable may be created to span the required distances. The cable may be required to span a continent, for example, such that light may be collected in one country and utilized in another.

The length of the concatenated fiber-optic cable may depend on the acceptable maximum attenuation levels, which may depend on the final use of the collected light. It may be desirable for the attenuation to be less than 0.5 dB/km, for example.

Super cables 413 may be generated from the fiber-optic cables 401. There may be a minimum of 4 primary cables 401 in each super cable 413. The super cable 413 may contain more primary cables. It is preferable that the super cable 413 is flexible to allow for sufficient maneuverability during the installation of the super cable. Therefore, there may be a limit to the number of primary cable 401 which can be combined to form a super cable 413 such that the required flexibility can be maintained.

Multiple super cables 413 may be used to transport the collected light from the collection location to the desired destination. By using one or more of such super cables described above, 10 kW or more of sunlight power may be transported to the desired destination. The desired destination may be a remote light conversion or processing center. It may be possible to transport several hundreds of megawatts, for example, to the destination by using multiple super cables.

There are a number of possible uses of sunlight transported in the manner described above. Reference will now be made to FIGS. 2A, 2B, 2C, 2D and 2E to describe a method of electricity generation.

This approach removes constraints of existing photovoltaic panels which integrate the sunlight gathering surface onto the conversion substrate, making it impossible to contemplate other uses of the collected sunlight or replacing any of the components when it is technically necessary.

FIG. 2A shows a light cabinet 311 from a side view with a plurality of racks 300 vertically spaced within the light cabinet 311, each containing rack mountings 312 and 313 vertically spaced within the rack 300. This illustrates one embodiment of where and how sunlight delivered by ‘super’ fiber-optic cables could be utilized; in this particular case, it is being converted to electricity. There could be one or more light cabinets 311 in a special shed or room inside a building where solar energy is converted to electricity. The ends of the ‘super’ fiber-optic cables 413, coming from the remote collector array(s) are received by respective intakes 301. In this way the ‘super’ fiber-optic cables 413, transporting sunlight, enter the light cabinet 311 and are distributed among the various racks 300 contained therein. As shown in FIG. 2A, there may be an intake 301 per rack 300, but other configurations are possible. Each rack mounting 312 is provided with an excess cable cradle 302 to take up any slack that might be necessary. In entering the rack 300, each ‘super’ fiber-optic cable is separated into at least two fiber-optic cables 401. The incoming fiber-optic cables 401 housed in the ‘super’ fiber-optic cables 413 are guided towards light boxes 304. Each rack mounting 312 may have one or more light boxes; five per rack mounting 312 are shown in FIG. 2B by way of example. Each optic-fiber cable 401 terminates at a ferrule 409 that guides the fibers into a light box 304. This is shown in expanded view 400. In the example given, each light box 304 takes the form of a container with four side walls two of which are denoted 411A, 411B, an upper surface 402 and a lower surface 414; the box receives fibers from one or more cables. The fibers are delivered individually into point source guides 410 arranged in a rectangular m×n matrix format (m<n) on either sidewall of the light box. This is shown in FIG. 2C. Each light box 304 is aligned on top of a solar cell chip 405 inside a drawer 406. The number of fibers depends on how large each solar chip is and how much electrical power one wants to generate from the chip. Since this is a question for how much capacity a user wants, it may be specified as a design parameter. At a possible minimum, each light box over a chip can generate up to 1 kW. This translates to either 100 fiber strands which can provide up to 1000 W where each fiber carries 10 W, or 64 fibers where each fiber caries 20 W per fiber to give a total of 1280 W, from a chip. Other configurations are possible. The preceding examples are given by way of illustration only.

Details of how the light box interfaces with the solar cell chip are shown in the expanded view 400 of FIG. 2C. Each fiber waveguide 210 in the fiber-optic cable 401 is fed through a ferrule 409 acting as a point source guide in the wall that guides it into light box 304. A point source has a defined and homogeneous light beam area, having a strong illumination focus, producing a sharply defined and evenly lit luminous spot. In a point source, the area from which the light emanates must not be large, i.e. must not form an ‘extended source’, since an extended source has different characteristics that make it work without having to integrate optics to pre-shape the beam profile.

The external side walls of the box should preferably be made from optically opaque materials such as anodized aluminum. In the detailed illustration in FIG. 2D, the interior of the box 304 is a specially designed cavity 110 (as shown in FIG. 2E) into which each fiber 210 delivers its output beam 412. Special fiber terminators can be used at the tips of the fibers to obtain the desired beam shapes within the cavity. In general, it is known that a fiber tip can be flat, lens-shaped, or any other desirable termination geometry for a particular exit beam shape. For the purposes of the light box in this embodiment, the desired fiber tip shape should result in an exit beam that expands from the fiber tip in a Gaussian fashion. Most of the cavity 110 is empty space except for a triangular-shaped prism 403 whose two surfaces facing the fibers are covered with dielectric reflecting coatings. The angle of the inclined sides of the prism, with respect to the horizontal lower surface of the box, is chosen such that light incident onto them from the fibers is reflected downward toward a first microstructured optical diffuser 404. The illustrated angle α is 45°. Other angles may be utilized, for example in the range 30° to 60°. The requirement is to redirect the incoming beams in overlap in an illumination zone. Multiple beamlets such as 412 from the fibers 210 should overlap at the edge of the first optical diffuser 404 because of diffraction at the exit of the fiber. To achieve this, the total distance, from the beam exit at the fiber 410 (in FIG. 2C) to the surface edge of the diffuser 404, should be chosen to guarantee beam overlap at the diffuser 404. A beam 412a is shown overlapping the beam 412 in FIG. 2E. A second diffuser 408 may also be used if necessary, below the first diffuser 404. Because of the angular spread of light from each fiber 210, and the distance from the beam exit to the edge of the diffuser, the beams from the fibers overlap and mix just before they reach the first diffuser 404. During transmission through the first diffuser 404, the beams are randomly mixed by the action of the microstructure in the diffuser. Light emerges from the other side of the diffuser with a substantially uniform distribution. If there is a second diffuser 408, the microstructure on the second diffuser 408 further randomizes the light, thus enhancing uniform distribution. The apparatus is constructed so that the output is a beam that is of substantially uniform intensity distribution and shaped to fit precisely over the active surface of the solar chip 405. This implies that the output surface of the last diffuser should be sized to have the dimensions of the active area of the solar chip 405.

While this might typically be a square or rectangle (for ease of manufacture), any suitable geometric shape could be utilized. Indeed, it is not essential that there is a precise match between the output surface of the diffuser and the active area of the solar chip, but it will readily be understood that it is much more efficient in terms of usage of the sunlight which has been transported through the fibers if this is the case.

In another embodiment, the diffused light from the fiber-optic waveguides 210 may be used to illuminate a panel of photovoltaic cells, such as is currently in use in external environments for the conversion of solar energy to electricity. The advantage derived from use of the apparatus described herein is that such a panel may be utilized indoors and therefore is not subject to environmental wear, as is currently the case. The current expectation is that illuminating photovoltaic panels of the known type may be less efficient than providing multi junction solar chips to capture the output of each light box, but that might not necessarily be the case.

Reverting back to the embodiment described herein, FIG. 2D shows an expanded perspective view of the light box and chip carrier of the embodiment described herein. This shows a rectangular output from the diffuser directly matching, the underlying solar cell chip on the chip carrier.

FIG. 2F illustrates a zoomed in section of FIG. 2D, showing one half of the arrangement in more detail. In an alternative embodiment, not shown, the prism may be replaced by a block of metal covered with a reflecting dielectric surface coating 116. This provides similar functionality to the prism, and may enable smaller and less expensive light boxes to be constructed as they receive an array of light guides only from one side of the box

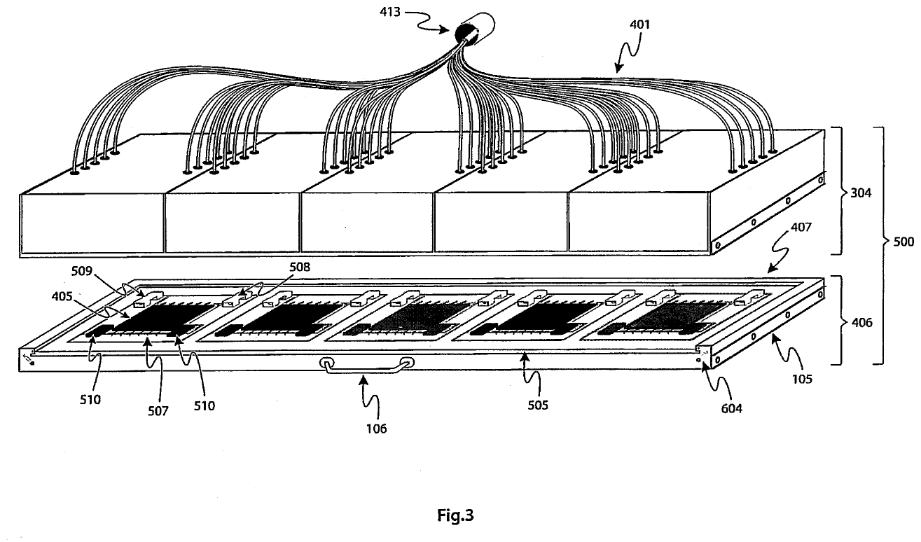

As shown in FIG. 2C, and more clearly in FIG. 3, the solar cell chips 405 are mounted on a carrier 505 inside a chip drawer 406. For heat dissipation purposes, the drawer should be thermally conductive. It could have a casing 407 manufactured from oxide-free copper material because of its excellent thermal conductivity. Embedded within the copper casing block is a piping structure 511 that is used to circulate a coolant, such as chilled water, that transports away waste heat generated during operation of each solar cell. This may be necessary even in the best solar cell chips, if an unacceptably high fraction of incident sunlight is converted to heat, which would tend to degrade the performance of the conversion process.

FIG. 3 shows the details of the structure of an apparatus on a typical rack mount 313 in a typical rack 300 of FIG. 2A. An assembled active conversion package 500 in FIG. 3 is comprised of the ‘super’ optic-fiber cable 413 that is separated into optic-fiber cables 401 that are fed into ferrules 409 that guide them into each light box 304, which interfaces with the cell drawer 406. Reference numeral 105 denotes a wheel/roller mechanism for rolling the drawer in and out. The cell drawer 406 is comprised of a copper block casing 407 on which is mounted a ceramic chip carrier 505 on top of which the solar cell chips 405 are attached and bonded with gold wires 507 and attached to the ceramic carrier with a thermally and electrically conductive adhesive. The drawer 406 has a handle 106 so that it may be easily slid out from the rack. To manufacture the assembly, a ceramic chip carrier initially is covered with a thin layer of highly conductive metal (such as gold); this layer is then lithographically defined into separate regions that are electrically isolated. These isolated regions are in turn defined into two electrical regions: one negative and the other positive. A negative terminal 508 and a positive terminal 509 are attached between which the solar cell chip 405 is mounted using a thermally and electrically conductive adhesive. Bypass diodes 510 protect each solar chip from any potential excess and uncontrollable current generation process by short-circuiting the chip to ground in the event of such an occurrence.

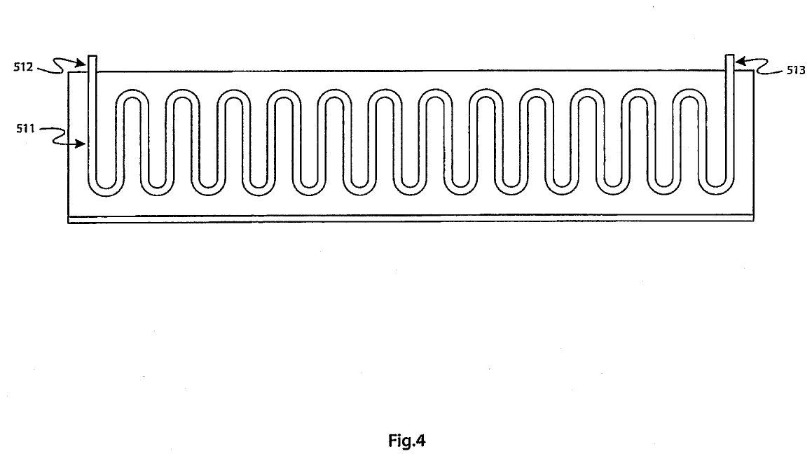

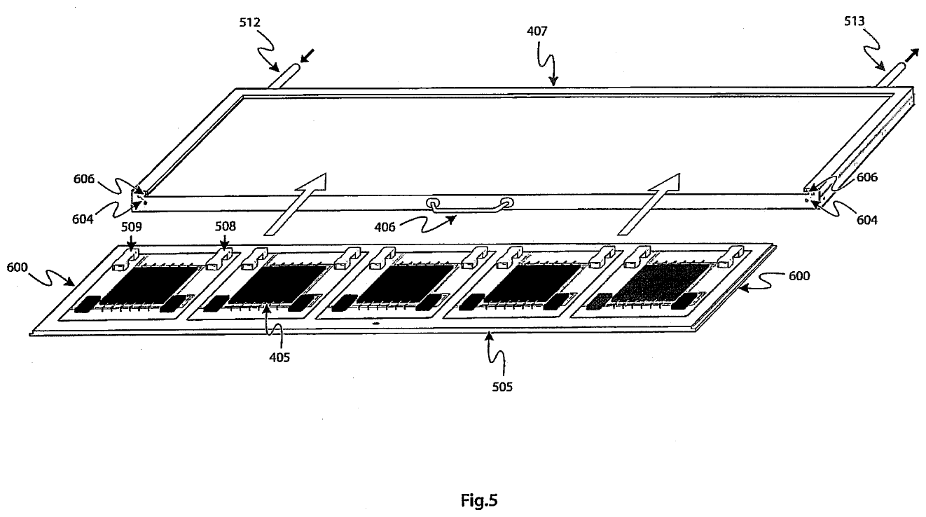

As shown in FIG. 4, embedded inside the copper block 407 on which the ceramic solar chip carrier 505 sits is a winding pipe 511 that allows a cooling fluid, such as ethylene glycol diluted with water or pure water, to be circulated and taken out at outlet 513. Such a cooling system can be closed loop. After exiting via port 513, the coolant can then be fed into an associated heat exchanger before it is fed back into the copper block at an inlet port 512.

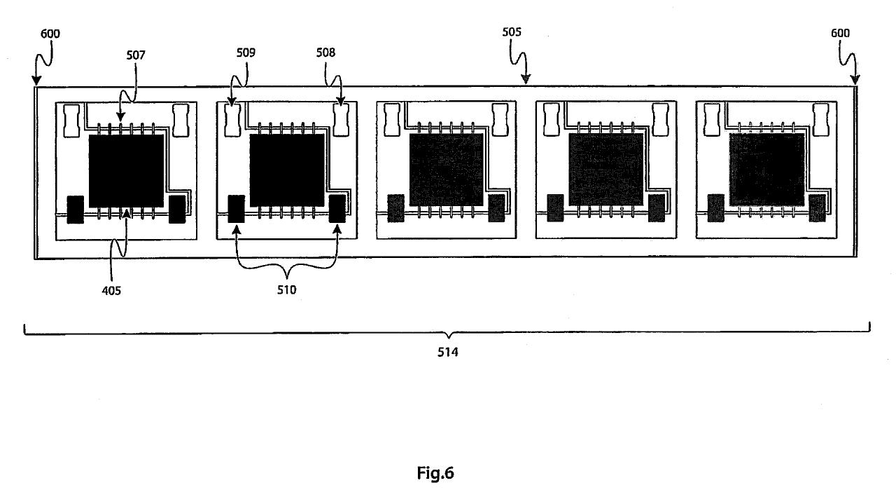

FIG. 5 illustrates details of the drawer comprising the copper block into which the ceramic chip carrier is installed. To make it easy to replace the bank of solar cell chips mounted on the carrier, each edge of the carrier is machined into a tongue 600 that fits into a slot 606 in the copper block 407. Once installed in the block, the carrier can be secured in place using latches 604 on the right and left sides of the copper block carrying the ceramic carrier. Whenever necessary, the carrier can be removed by simply unlatching the mechanism and pulling it out. The carrier and the block should make intimate contact with each other to facilitate thermal conduction. Heat transferred to the block from the carrier is transported away by the coolant described above with reference to FIG. 4.

A ceramic carrier populated with a bank of solar cell chips is shown in FIG. 6. As discussed, each solar cell chip on the carrier is protected with bypass diodes in case of excessive electrical current. Electrical output from the solar cell chips is available from positive and negative terminals 508 and 509, respectively. Wire bonds 507 on two sides of the cell, and a thermally and electrically conductive paste on the bottom side of the cell attach the p and n side of the solar cell diode to the appropriate output terminal. Also, as described earlier, the tongue 600 on each side of the ceramic carrier slots into the copper block 407 that serves as a heat sink.

Some of the advantages of the scheme described in this invention should now be apparent to those skilled in the art. By separating the function of light collection from light transport, and the light collection process from the conversion process, one effectively makes the photovoltaic system future-proof. Technology advances and developments that impact performance improvements in new solar cell chips can be readily taken advantage of. All that is required is removal of the old ceramic carrier 505 on which solar cell bank 514 sits. New chip carriers (with new solar cell banks of higher performance) can then be readily swapped in to replace the old ones. FIG. 6 identifies a replaceable structure in the form of cell bank 514. The cell bank is the complete replaceable unit which comprises the carrier base 505, the cells 405 and the surrounding feature sets such as the diodes 510, wire bonds 507 etc. The cell bank can be slotted in and out of the casing 407 for replacement purposes, once the casing has been removed from the rack, for example by sliding or rolling it out using the handle. For owners of installed systems, this is a less expensive option than replacing an entire infrastructure. This partial replacement option is available to both utility scale power plants and to individual home photovoltaic systems. Another advantage of the new general methodology is that it allows a relatively straightforward process for increasing generating capacity of existing power plants. If desired, several empty solar chip storage racks, earmarked for future capacity expansion can be included during the initial installation phase. The empty racks can be populated with solar cell chip carriers at a later date when additional capacity is needed or when funds become available. This unmatched flexibility to scale up or scale down could give large, renewable solar energy utility plant operators decided advantages over their competitors who rely on traditional coal or gas plants.

As mentioned earlier, a significant advantage of separating the harvesting of sunlight from its application is to enable multiple applications which use the same front end harvesting process.

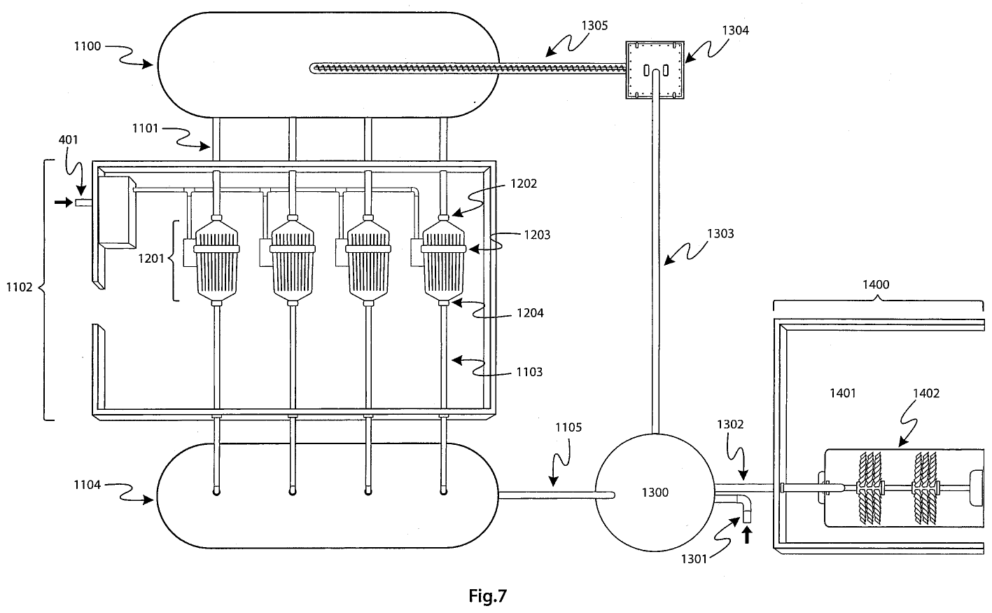

Another application of the solar collection and transportation system is the transfer and storage of solar energy in the form of heat. Reference will now be made to FIGS. 7, 8A, 8B and 9 to describe a method and system for heat storage and conversion.

In the following description, a thermal energy storage system is described wherein the thermal energy is derived from sunlight delivered to the storage facility via fiber-optic cables 401 of the type discussed above which are attached to a solar collection apparatus of the type described with reference to FIGS. 1A and 1B. The storage system comprises a replaceable and upgradable cold particle storage tank for accommodating heat storage microparticles which play the role of the heat transfer media as well as that of thermal storage media. The storage tank is installed with its axis aligned along the horizontal. A thermal receiver comprises an input pipe for transferring particles from cold particle storage to the receiver at a rate controlled by a rotary inlet valve. The valve connects the cold particle storage to an oven for heating the particles. The oven is partitioned into thin parallel compartments through which particles flow in a laminar fashion. A fiber-optic scanning mechanism attached on top of the oven constitutes part of the receiver. The scanning mechanism (scanner) is equipped with a motorized belt system to permit back and forth motion of the fiber tips deployed over the oven. An outlet pipe is provided for transferring hot particles at a rate controlled by an outlet rotary valve to a common duct connected to a combined hot particle storage and thermal exchange system. A programmable logic controller synchronizes and controls the opening and closing of the particle inlet and outlet rotary valves.

The system comprises a replaceable and upgradable hot particles storage tank 1104 with varying volume requirements with capacities typically varying from 1 to 150 kilotons, or higher. The capacity of the hot particle storage tank 1104 may vary in line with the capacity of the cold particle storage tank 1100 according to the volume of microparticles that need to be stored to achieve the required energy storage capacity (defined as a specific number of hours of thermal storage with a specific level of electrical energy output (in kWh or MWh), at a specific net power block percent efficiency). The lid of the tank has openings to receive hot particle outlet pipes that originate from one or multiple thermal receivers. The storage tank is installed with its axis aligned along the horizontal.

The system can have a heat exchange vessel with a typical capacity of between 1 to 20 kilotons, or higher, installed with its axis perpendicular to the horizontal. The capacity of the heat exchanger vessel may vary according to the required energy storage capacity of the hot particle storage tank 1104 and the required particle output volume. It is provided with a coiled copper pipe with an inlet and outlet for cold water and steam, respectively. The heat exchanger is further provided with a particle outlet port and a rotary release valve. The rotary release valve sits at the top port to the vessel.

An ideal particle storage vessel should be designed to minimize its surface-to-volume ratio for a given storage capacity. The objective of such a design is to reduce, as much as possible, the external surface of the vessel through which radiative heat losses could be suffered, while maximizing the particle storage capacity of the vessel.

Another component of the system is a hopper with a cover. The hopper is connected with a pipe to the lower chamber of the heat exchanger through the rotary release valve. Below the hopper is a programmable logic controller for setting control signals for opening and closing of the rotary valve between the upper hot particle storage chamber and the lower heat exchanger chamber. The programmable logic controller also controls the opening and closing of the rotary valve between the hopper and the lower heat exchange chamber.

An inclined screw conveyor system is connected to the closed hopper. The screw conveyor receives particles from the lower heat exchanger chamber through the hopper and delivers them (against gravity) to the cold particle storage tank. The screw conveyor is controlled by the programmable logic controller under the hopper. At the top of the cold storage tank, the screw conveyor delivers the particles to an internal pipeline that distributes them along the entire length of the cold storage tank through valve-controlled openings along its length. This enables even particle distribution inside the cold storage tank.

A power block, which in one possible embodiment may be comprised of a steam turbine generator, boiler feed water pump and an air-cooled condenser, is connected to the heat exchanger in the lower chamber of the hot particle storage. The power block is connected via the steam pipe outlet from the upper chamber of the heat exchanger.

This overall system provides a natural or designed topographic scheme wherein the cold particle storage tank is installed at a higher elevation than the building shed housing the thermal receivers. This topographic scheme permits use of gravitational potential to deliver particles to the thermal receivers. A similar relationship exists between the closed hopper and the cold particle storage tank, wherein the inclined screw conveyor is used to deliver used particles back to the cold particle storage (against gravity).

The above components of the system will now be described in more detail.

The method described herein uses solid matter as heat storage and heat exchange medium. The method utilizes microstructured solid-state particles, having high thermal absorption and low emissivity properties. High absorption means the particles can be rapidly heated to very high temperatures, and the low emissivity means the particles can retain heat longer.

The microparticles that can be used as storage media and heat transfer media for the system described herein can have any chemical composition, as long as they possess heat capacities above 700 J/kg ° C. Examples of suitable particles include, but are not limited to, (i) silica sand, (ii) quartz sand, (iii) alumina, (iv) silicon carbide, (v) graphite pebble, and (vi) proppants. These materials are all abundant and inexpensive. Of these, proppants, such as used in hydraulic fracturing treatment, are the preferred media for having the most suitable physical properties for thermal energy storage applications, since their physical properties, especially their geometry, can be precisely controlled. Ceramic proppants have the most suitable physical properties for thermal energy storage applications because they can be precisely engineered. The preferred size distribution for the particles used can range from 100 μm to 2 mm.

The use of microparticles avoids the disadvantages of heat transfer fluids currently utilized in thermal storage. Molten salt has usually been the heat transfer fluid of choice in such systems because of its high heat capacity. However, most salts are corrosive, thus subjecting any vessel, piping, and pumping system used in the construction of the power plant to unnecessary damage. Frequent maintenance to replace corroded components results in long down times and high annual maintenance costs.

FIG. 7 shows an overview of the solar thermal platform plant that uses microparticles. Cold particles are stored in a storage tank 1100, and are used to feed a heating system in a light processing center 1102, where the microparticles are fed in batches and heated using sunlight. The cold particle storage tank 1100 may be of different volumes in order to accommodate particles with capacities typically varying from 1 to 150 kilotons, or higher. The capacity of the cold particle storage tank 1100 may vary according to the volume of microparticles that need to be stored to achieve the required energy storage capacity (defined as a specific number of hours of thermal storage with a specific level of electrical energy output (kWh or MWh), at a specific net power block percent efficiency). The cold particle storage tank 1100 is positioned with its axis on a horizontal orientation, and is installed in an elevated configuration with respect to the other units of the system to facilitate the microparticles being transferred to the light processing center 1102 by gravitational potential through several feeding pipes 1101, thus conserving process energy. The microparticles stored in the cold particle storage tank 1100 can be easily replaced and upgraded when needed. The light processing center 1102 receives the microparticles from the cold particle storage tank 1100 and holds them in at least one heating surface in a thermal receiver 1201.

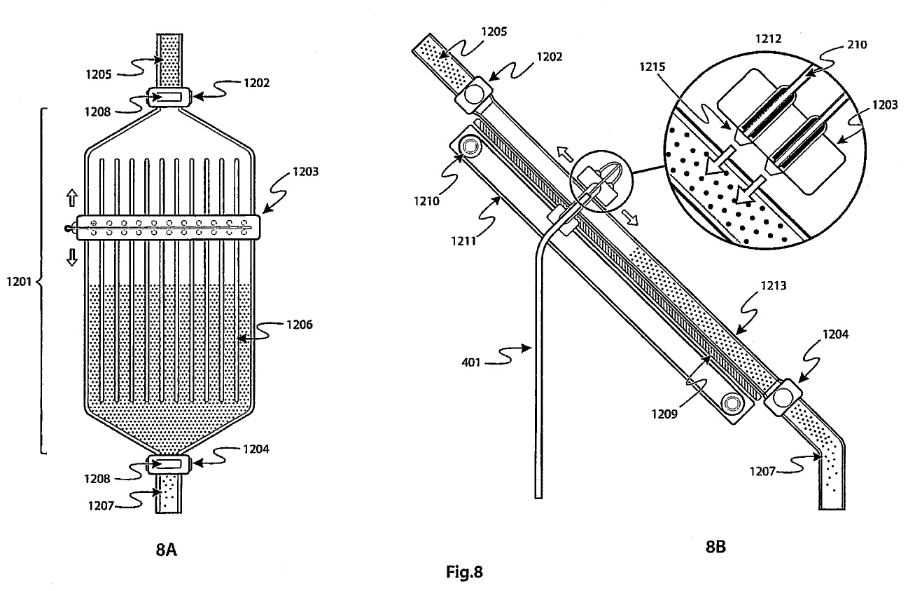

The sunlight used to heat the microparticles is delivered to the system via a fiber-optic cable 401 having multiple individual fibers 210. The fiber-optic cable 401 is connected to the system via the light processing center 1102, where at least one thermal receiver 1201 having a heating surface is housed. Light transported by the fibers 210 is aggregated from a number of solar collectors 100 that may be located near or remotely from the light processing center 1102. The solar collectors 100 are not shown in FIG. 7 for reasons of clarity. The at least one thermal receiver 1201 installed in the light processing center 1102 is provided with a fiber-optic scanner 1203 that is connected to the fiber-optic cable 401, and which is responsible for heating the microparticles fed into the thermal receiver 1201. Attached to each thermal receiver 1201 is an input and output microparticle port controlled, respectively, by rotary gate valves 1202 and 1204. The structure of the thermal receiver and its different parts will be explained in more detail in the description of FIG. 8 below.

The output pipes 1103 of the at least one thermal receiver 1201 having a heating surface are connected to multiple openings on the lid of a hot particle storage tank 1104, which stores the heated microparticles that will then be used to feed a heat exchanger 1300. The hot particle storage tank 1104 may be of different volumes in order to accommodate particles with capacities typically varying from 1 to 150 kilotons, or higher. The capacity of the hot particle storage tank 1104 may vary in line with the capacity of the cold particle storage tank 1100 according to the volume of microparticles that need to be stored to achieve the required energy storage capacity (defined as a specific number of hours of thermal storage with a specific level of electrical energy output (kWh or MWh), at a specific net power block percent efficiency). The hot particle storage tank 1104 is positioned with its axis in a horizontal orientation, and is placed at a level which is lower with respect to the light processing center 1102, to facilitate the microparticles being transferred from the light processing center 1102 to the hot particle storage tank 1104 by gravitational potential through the output pipes 1103.

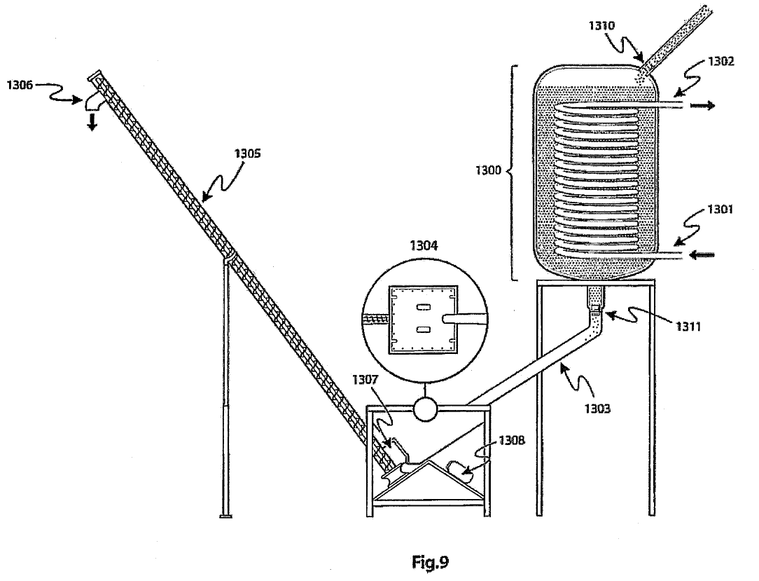

The hot particles are delivered to a heat exchanger 1300 by a hot particle transfer pipe 1105. Once the microparticles are delivered, the heat exchanger 1300 takes in cold water from a water inlet 1301. Inside the heat exchanger 1300, particles transfer their thermal energy to the cold water pipe to heat the water flowing inside it to produce steam that is delivered to the power block 1401, where it is used to drive a turbine 1402 to generate electricity inside a utility unit 1400. Particles exit the heat exchanger via a pipe 1303 with little to no thermal energy left. They are delivered through a hopper 1304 to either an inclined screw conveyer system 1305 or other form of conveyor system. At this point, the temperature of the particles should be close to room temperature or the ambient, and can be re-delivered to the cold particle storage tank 1100 where they can be reused in the system. The cycle begins anew once the particles are back in the cold particle storage tank 1100. The heat exchanger 1300 and the different components of the hopper and inclined screw will be described in more detail in the description of FIG. 9 below.

FIG. 8A shows the front view with details of the component parts comprising the solar thermal receiver 1201, which resides inside of the light processing center 1102. Cold particles enter the thermal receiver through a rotary valve 1202 connected to the top of the thermal receiver, and which is positioned after a pipe piece 1205 that connects the cold particle storage tank 1100 with the thermal receiver 1201.

The thermal receiver 1201 is partitioned into several, thin and parallel hollow sections 1206 that promote laminar flow of particles through it. Because of the inclined positioning of the receiver (as shown in FIG. 8B, and described in more detail below), particle flow is facilitated by gravity.

Sunlight energy is delivered to the fiber-optic scanners 1203 from the fiber optic cable 401. The fiber-optic cables 401 are separated into individual fibers 210 that are distributed along the surface of the fiber-optic scanners 1203, and are attached to a series of light delivery heads 1212 that terminate in a fiber tip 1215 which is directed at the heating surface of the thermal receiver 1201. The enclosure 1213 of the thermal receiver 1201 containing the particles is composed of a semitransparent ceramic material that enables energy transfer from the fiber tip 1215 to the microparticles retained inside the thermal receiver 1201. This enclosure can be made from any ceramic material with good thermal properties, such as, but not limited to silicon carbide, boron nitride, beryllium oxide, and aluminum nitride. The preferred material for use in the heating surface of the thermal receivers 1201 is pyrolytic boron nitride, for its high thermal conductivity and transparency. Each thermal receiver 1201 is partitioned internally into separate parallel sections where particles can flow in laminar fashion by gravitational potential toward the bottom rotary valve 1204. When a thermal receiver 1201 is filled with particles, they are constrained to remain in the thermal receiver 1201 for as long as the bottom rotary value 1204 is closed. The fiber-optic scanner 1203 moves continuously up and down the heating surface of the thermal receiver 1201, uniformly heating the particles for as long as needed, until the desired temperature is reached. The temperature of the particles is measured by a sensor 1208, which determines how long the particles will remain inside the thermal receiver 1201. Once the desired temperature of the particles has been reached, the sensor generates a signal that activates the rotary gate valve 1204 to allow the heated particles to flow to the hot particle storage tank 1104. Using a controller, such as a programmable logic controller (PLC), the act of closing and opening the rotary gate valve 1204 can be synchronized with the opening and closing of the rotary release valve 1202 to enable the thermal receiver 1201 to be replenished with cold microparticles as soon as the heated microparticles are released. The temperature of the microparticles in the present system can be elevated to whatever value is deemed necessary within the thermal limitations of the material used for the microparticles. Furthermore, since the system heats the microparticles in batches, there is no need for particle recirculation during the heating process.

FIG. 8B shows a side view of the thermal receiver, providing more details of the mechanism used to effect scanning of the fiber delivery tip 1215 over the surface of the thermal receiver 1201. A digital motor 1210 is coupled through a belt 1211 to a hub near the rotary valve 1204. The fiber delivery head 1212 comprising the fiber-optic scanner 1203, the fiber-optic distribution cable 210 and the fiber tip 1215, is attached to the belt 1211 in such a manner that as the belt 1211 moves back and forth, it carries the fiber head 1212 with it. In this way the heating surface of the thermal receiver 1201, and hence the particles inside it, are uniformly heated. Another perspective of the light delivery fibers in the scanner is shown in the enlarged view of the light delivery head 1212, where is shown how the fibers 210 are attached. The fibers 210 can be attached to the fiber-optic scanner by any suitable mechanism, such as a screw thread on the fiber tip, which connects to a thread on the fiber-optic scanner 1203. Any other known technology available for connecting optic-fibers to surfaces can be used herein. Note that the fibers are terminated with tips 1215 that properly shape the beams before incidence on the oven surface. The thickness of the thin sheet formed by the particles inside the oven can range from a millimeter to several millimeters, in order to allow for a limited number of microparticle layers to be formed in each thermal receiver 1201 for each batch, to allow a more uniform temperature to be reached throughout the different particle layers during the heating process. Placed behind the heating surface of the thermal receiver 1201, is a thermal reflector 1209 that retro-reflects any heat that is not absorbed in the first pass by the microparticles.

Once heated to the required temperature, the temperature sensor sends a signal to the rotary gate valve 1204 that releases the hot particles, which are conveyed to a hot particle storage tank 1104. The hot particle storage tank 1104 is positioned at a lower elevation with respect to the thermal receiver 1201 and the pipe 1207 that delivers the hot particles from the thermal receiver 1201 to the hot particle storage tank 1104, so that gravitational potential can be utilized to convey the particles.

One of the important consequences of using microparticles as the heat transfer medium as well as the storage medium is the enabling of a high temperature regime of operation. By nature, microstructured particles exhibit relatively high surface-to-volume ratios that are conducive to higher heat transfer properties compared to bulk media. This means operating temperatures of up to 800° C. or higher are potentially feasible. Since the Carnot efficiency of a heat plant depends on the temperature difference between the highest attainable temperature of the working fluid (medium) and the ambient temperature, the proposed approach would lead to much higher solar-to-electric conversion efficiencies compared to existing systems.

The system presented herein for thermal energy storage minimizes parasitic energy usage, as it does not require use of additional process energy to keep the solid media molten or use process energy to recirculate the media. Plant process energy usage is parasitic and reduces overall plant output.

FIG. 9 illustrates the path taken by the particles after they leave the hot particle storage tank 1104 and arrive at the heat exchanger 1300 via the hot particle transfer pipe 1105, connected to the heat exchanger 1300. The heat exchanger 1300 is formed by a vessel having a cylindrical shape and positioned at a lower height with respect to the hot particle storage tank 1104 to facilitate the transfer of the particles by gravity. The vessel, having a typical capacity for 1 to 20 kilotons, or higher, is installed with its axis perpendicular to the horizontal. The capacity of the vessel may vary according to the required energy storage capacity of the hot particle storage tank 1104 and the required particle output volume. The heat exchanger 1300 is provided with a coiled copper pipe positioned inside the vessel, having an inlet 1301 and outlet 1302 for cold water and steam, respectively. The heat exchanger 1300 is also provided with two rotary release valves, one installed at the top of the vessel 1310 that controls the transfer of hot particles from the hot particle storage tank 1104 and another installed at the bottom of the vessel 1311, for release of the particles depleted of their heat, to the sealed hopper 1304. It is in the heat exchanger that the thermal energy stored in the particles is transferred to the cold water pipe with water flowing through it that is eventually converted to steam. The hollow copper coil occupying most of the volume inside the vessel of the heat exchanger 1300 serves as the piping that lets cold water into the heat exchanger 1300 through a port 1301, where it is heated and converted to steam. The outlet 1302 of the copper coil, which should now contain steam, is fed into the power block 1401 to drive a steam turbine generator 1402. After heating the water in the coiled copper pipe, the particles exit the heat exchanger 1300, exhausted of their thermal energy, through a rotary release valve 1311, and are then conveyed through a pipe 1303 to a sealed a hopper 1304. The sealed hopper is installed at a height lower than the heat exchanger 1300 to allow the particles to be transferred by gravity from the heat exchanger 1300 to the hopper 1304. Installed in the hopper 1304 is a mechanism for feeding the particles to a screw conveyer system 1305 that moves the particles against gravity to feed them back to the cold particle storage tank 1100. The screw conveyer system 1304 is inclined at an angle between 45° to 60° to the horizontal to facilitate connection to the cold particle storage tank 1100 through a pipe 1306. The screw conveyance system is driven by motor 1307, which is installed at its base. An associated control box 1308 is located underneath the hopper.

The proposed implementation of thermal energy storage has a number of benefits. First, the approach adheres to a principle of minimization of process energy usage. As much as possible, gravity has been used to aid processes that would otherwise require energy expenditure. Unlike in prior art, the storage medium is not pumped around the circulatory loops. Second, the heat transfer and storage media in the proposed system are stable, widely available, inexpensive, chemically benign, and safe. The entire implementation is environmentally and economically sustainable.

1-4. (canceled)

5. A solar collector energy conversion system comprising:
a solar collector apparatus adapted to collect sunlight at a collection location, the solar collector apparatus comprising an array of solar collector modules mounted on a support and orientable to collect sunlight, each solar collector module including:
an outer dish-shaped surface and an inner concave collection surface, which is reflective, and which is configured to collect sun rays and to reflect them towards a mirror location;
coupling means operable to couple a respective light receiver to the solar collector module at a light collection region of the solar collector module; and
a mirrored surface located at the mirror location to receive sun rays reflected from the collection surface and to reflect the sun rays to the respective light receiver at the light collection region,
wherein each solar collector module in the array is attached via the coupling means to the respective light receiver in the form of a respective flexible optical-fiber, wherein the optical-fibers from the array are housed in parallel arrangement in a flexible primary cable for transporting the sunlight from the collection location to a conversion location separate from the collection location, wherein the outer dish-shaped surface of each of the solar collector modules is configured to securely fit in and be removable from a holding substructure of the support on which the array of solar collector modules are mounted; and
a solar energy conversion apparatus arranged at the conversion location and adapted to receive sunlight transported by the optical fibers and to convert the transported sunlight to an alternative form of energy.

6. The solar collector energy conversion system according to claim 5 wherein the solar collector apparatus comprises a plurality of arrays, wherein the primary cable from each array is housed in a super cable.

7. (canceled)

8. The solar collector energy conversion system according to claim 5 wherein the primary cable has a length of greater than 0.5 km.

9. The solar collector energy conversion system according to claim 8 wherein each optical-fiber is constructed to transmit sunlight in the range of wavelengths from 350 nm to 2500 nm.

10. The solar collector energy conversion system according to claim 5 wherein the alternative form of energy is electricity.

11. The solar collector energy conversion system according to claim 10 wherein the solar energy conversion apparatus comprises at least one light collection housing at the collection location adapted to receive sunlight transported by the optical fibers to produce a beam for illuminating a photovoltaic component; and
a photovoltaic component located to receive the beam and to generate electric energy from the beam;
wherein the photovoltaic component is located below the light collection housing.

12. The solar collector energy conversion system according to claim 11 wherein the beam produced from the transported sunlight is of a predefined geometric shape, and wherein the photovoltaic component comprises at least one photovoltaic chip having a photo reception surface adapted to match the beam of predefined geometric shape.

13. The solar collector energy conversion system according to claim 12 wherein the photovoltaic component comprises a plurality of photovoltaic chips supported by a replaceable chip carrier mounted on a thermally conductive block.

14. The solar collector energy conversion system according to claim 13 comprising a set of light collection housings, each arranged to illuminate a respective photovoltaic chip, wherein the block supporting the photovoltaic chips is movable relative to the light collection housings to enable the replacement of photovoltaic chips.

15. The solar collector energy conversion system according to claim 5 wherein the alternative form of energy is heat.

16. The solar collector energy conversion system according to claim 5 wherein the conversion apparatus comprises a support to which remote tips of the optical fibers is/are secured, the support being movable relative to a surface carrying thermal storage particles, whereby the thermal storage particles are heated by scanning the support with respect to the surface.

17. A solar collector module comprising:
an outer dish-shaped surface and a concave inner collection surface, which is reflective, and which is configured to collect sun rays and to reflect them towards a mirror location;
coupling means operable to couple a light receiver in the form of an optical fiber to the solar collector module at a light collection region of the solar collector module; and
a mirrored surface located at the mirror location to receive sun rays reflected from the collection surface and to reflect the sun rays to the light receiver when coupled to the solar collector module at the light collection region,
wherein the outer dish-shaped surface of the solar collector module is configured to securely fit in and be removable from a holding substructure of a support on which an array of the solar collector modules are mounted.

18. A solar collector assembly comprising a solar collector module according to claim 17 in combination with the light receiver in the form of at least one optical-fiber.

19. The solar collector module according to claim 17 wherein the concave collection surface is a truncated parabola rotated about its origin.

20. The solar collector module according to claim 17 wherein the mirror location is located at a first focal point of the concave collection surface, the first focal point located along a central axis of the collector module.

21. The solar collector module according to claim 20 wherein the light collection region is located at a second focal point spaced from the first focal point along the central axis of the collector module.

22. The solar collector module according to claim 17 comprising an optically transparent covering which extends over the upper area of the collector module.

23. A solar collector apparatus comprising the array of solar collector modules, each according to claim 17.

24. The solar collector apparatus according to claim 23 wherein the array is mounted on a movable support to track the movement of the sun.

25. The solar collector assembly according to claim 18 wherein the optical fiber comprises an elongated cylindrical glass core surrounded by cladding of a refractive index smaller than of the core, the optical-fiber designed to transmit light in the range of 350 nm to 2500 nm, and not in a band of 20 nm centered around 1430 nm.

26. The solar collector assembly according to claim 25 wherein the glass core has a diameter of between 100 μm and 1 mm.

27. The solar collector assembly according to claim 26 wherein the optical fiber is housed in a primary cable located in parallel alignment with multiple optical fibers in the primary cable.

28-30. (canceled)

31. A solar collector energy conversion system comprising:
a solar collector apparatus adapted to collect sunlight at a collection location, the solar collector apparatus comprising an array of solar collector modules mounted on a support and orientable to collect sunlight, each solar collector module including:
an outer dish-shaped surface and an inner concave collection surface, which is reflective, and which is configured to collect sun rays and reflect them toward a mirror location;
coupling means operable to couple a respective flexible optical fiber to the solar collector module at a light collection region of the solar collector module; and
a mirrored surface located at the mirror location to receive sun rays reflected from the collection surface and to reflect the sun rays to the respective flexible optical fiber at the light collection region,
wherein each solar collector module in the array is attached via the respective coupling means to the respective optical fiber, wherein the optical fibers from the array are housed in parallel alignment in a flexible primary cable for transporting the sunlight from the collection location to a conversion location separate from the collection location, wherein each optical fiber comprises an elongated cylindrical glass core surrounded by cladding of a refractive index smaller than that of the core, the optical fiber designed to transmit all wave lengths of sunlight in the range of 350 nm to 2500 nm, excluding a bandwidth of 20 nm centered around 1430 nm.

32. The solar collector energy conversion system according to claim 31 comprising a solar energy conversion apparatus arranged at the conversion location and adapted to receive sunlight transported by the optical fibers and to convert the transported sunlight to an alternative form of energy.

33. The solar collector energy conversion apparatus according to claim 31 wherein the glass core has a diameter of between 100 μm and 1 mm.

34. The solar collector energy conversion apparatus according to claim 31 wherein each solar collector module comprises an respective optically transparent covering which extends over an upper area of the solar collector module and supports the mirrored surface.
